(19) United States
(12) Patent Application Publication
(10) Pub. No.: US 2003/0232552 A1
(43) Pub. Date: Dec. 18, 2003

(54) Bonded polyester fiberfill battings with a sealed outer surface having improved stretch and recovery capability

(76) Inventor: Peter K.F. So, Tsuen Wan (SG)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/336,414

(22) Filed: Jan. 3, 2003

Related U.S. Application Data
(60) Provisional application No. 60/345,266, filed on Jan. 4, 2002.

(51) Int. Cl. B32B 5/02

(52) U.S. Cl. 442/59; 428/292.1

(57) ABSTRACT

Polyester fiberfill batts having improved stretch capability for apparel and other uses are prepared of polyester fiber and binder fiber, sprayed with a soft resin by oven bonding and hot roll treatment under certain specified conditions. This provides a bonded batting which is characterized by softness and drapability, good insulating performance, low levels of fiber leakage or percolation through shell fabrics, enhanced durability when laundered by washing/drying or by dry cleaning, and enhanced structural integrity whereby it hangs freely without the need for quilting into small size panels, as well as improved stretch capability.

### CROSS REFERENCE(S) TO RELATED APPLICATION(S)

This application claims benefit of priority from Provisional Application No. 60/345,266 filed Jan. 4, 2002.

### FIELD OF THE INVENTION

This invention is concerned with improvements in the stretch capability of bonded polyester fiberfill battings.

### BACKGROUND OF THE INVENTION

Polyester fiberfill (sometimes referred to as polyester fiberfilling material) is well accepted as a reasonably inexpensive filling and/or insulating material for pillows, cushions and other furnishing materials, including bedding materials, and in apparel, and is manufactured and used in large quantities commercially. For many of these uses, as disclosed, e.g., in Tolliver U.S. Pat. No. 3,772,137; Stanistreet U.S. Pat. No. 4,068,036; Scott U.S. Pat. No. 4,129,675; Pamm U.S. Pat. No. 4,281,042; Frankosky U.S. Pat. No. 4,304,817; Siniscalchi U.S. Pat. No. 4,551,383; and LeVan U.S. Pat. No. 4,869,771, it has been desirable to make bonded batts, e.g., by spraying a resin-bonding agent, usually of an acrylic polymer, or by blending the polyester fiberfill with binder fibers, such as are well known in the art, or by use of both a resin-bonding agent and binder fibers.

To improve the aesthetics of polyester fiberfill, it has often proved desirable to “slicken” the fiberfill with a coating of durable (i.e., wash-resistant) coating that has usually been a silicone, i.e., a cured polysiloxane as disclosed, e.g., by Hofmann U.S. Pat. No. 3,271,189; Mead et al U.S. Pat. No. 3,454,422; Ryan U.S. Pat. No. 3,488,217; Salamon et al U.S. Pat. No. 4,146,674; LeVan, above; Takemoto Oil and Fat Co., Ltd., Japanese Published Application No. 58-214,585(1983); or other types such as the polyalkylene oxide variety disclosed by, e.g., Marcus U.S. Pat. No. 4,818,599.

U.S. Pat. No. 5,527,600 discloses an easily prepared, homogeneous batting that is characterized by softness and drapability to conform to the wearer's body, good insulating performance, low levels of fiber leakage through shell fabrics, even after laundering, enhanced durability to laundering by washing/drying or by dry cleaning, and enhanced structural integrity whereby the batting is able to hang freely without the need for having it quilted into small size panels. However, for some uses, especially in apparel, it has been desired to provide batts with some degree of “stretchable” characteristics, so that a garment which is made of stretchable shell fabrics and stretchable batts will allow comfortable control with enhanced freedom of movement.

### SUMMARY OF THE INVENTION

The present invention solves the problems of the prior art by providing a stretchable batt. The “stretchability” of the batt of the present invention is measured by the tensile strain of the batt, since tensile strain is a measure of how much stretch there is in a material for a given load. Thus, in accordance with the present invention, there is provided a bonded batt, comprising a blend of polyester fiberfill, intimately mixed with a binder fiber, wherein the batt has a tensile strain greater than about 35% at a 3-pound load.

The tensile strain of the batts of the present invention is achieved by the processing conditions under which the batts are made. Thus, according to another aspect of the invention, there is provided a process for preparing a bonded batt, comprising forming a blend of polyester fiberfill intimately mixed with a binder fiber, preparing a continuous batt from said blend, said batt having an upper face and a lower face, advancing said batt through one or more spray zones, whereby both faces of the batt are sprayed with resin, heating the sprayed batt in an oven to cure the resin and soften the binder material, followed by hot-rolling the heated batt at 200-220° C. for about 8 seconds to achieve intimate contact between the resin and the fibers in the faces of the batt, and cooling the rolled batt. Such hot-rolling is effected by use of heated rolls in an S-wrap configuration. The rolls may have a clearance of from 2 to 10 mm, depending on the final batting thickness desired.

### BRIEF DESCRIPTION OF THE DRAWINGS

FIG. 1 shows a series of tensile strain curves for a batt made according to the prior art.

FIG. 2 shows a series of tensile strain curves for a batt made according to the present invention.

### DETAILED DESCRIPTION OF THE INVENTION

Thus, the invention provides fiberfill batts, such as are needed for use in premium apparel, by first preparing a homogeneous blend of polyester fiberfill (70-96% by weight of the blend) and a suitable binder fiber (4-30% by weight of the blend). This blend is converted on a card or garnet to a web which may then be layered or cross lapped to form a batting to whose upper (and preferably serially also to whose lower) face is applied a suitable latex (e.g., a colloidal dispersion of acrylic polymers and/or copolymers in water, discussed in more detail hereinafter), e.g., by spraying. The sprayed batting is heated, e.g., conveniently by being passed through a heated oven to dry the coating(s) and to polymerize the polymeric component(s) to high molecular weight, and to activate the binder fiber. This may be conveniently done, for example, in three passes through such an oven, two to serially dry and partially cure each such coating, after it has been applied to any face, and a final pass to supplement the other(s) and to ensure activation of the binder fiber in preparation for any hot-rolling, in which the bonded batt is passed around heated rolls in an S-wrap configuration to soften and spread the cured resin and ensure its complete and even distribution among the fibers in the face(s) (large surfaces) of the batt to prevent fiber leakage through such surface(s) of the batt and, at the same time, to ensure that the batt is of the desired thickness.

The resins that may be used herein are termed variously, by different manufacturers, as “soft” or “medium”, or even “very soft”, but are characterized by having second order glass transition temperatures (T_{g}) of about ° C. or less, and preferably from about 0 degrees down to about −30 degrees Celsius. They provide both softness and drapability to the batt when used in, e.g., apparel, while acting as barrier to fiber leakage from the batt. The weight of the fibers in the batt (i.e., of the blend of polyester fiberfill and of binder fiber) is referred to as the “basis weight” of the batt, i.e., before the sealing resin is sprayed on. The final batts may have a basis weight of 1.5 to 12 oz/yd² (50 to 400 g/m²) and a thickness of 0.07 to 0.20 inch/oz/yd²(0.05 to 0.15 mm/g/m²).

Thus the batts of this invention are prepared from a blend of polyester fiberfill and binder fibers, and the fibers in the face(s) are sealed by a suitably soft-type resin coating. The polyester fiberfill may all be slickened, e.g., as described herein, or may be a blend of slickened and unslickened fibers. The fiberfill may be solid, hollow, or a blend of solid and hollow fibers and is not limited to any type of fiber cross section, i.e., it may be of cruciform, trilobal, Y-shaped, dog bone, scalloped oval, and other non-circular cross sections as well as round. The fiberfill has a denier per filament (dpf) within the range of 0.2 to 10, with a dpf of about 1.50 to 1.65 being very useful, and constitutes about 70 to 96% by weight of the blend. Both metric units, such as dtex and denier are used herein, 1 dtex being the same as 0.9 denier per filament (dpf). The individual fibers are provided with crimp by conventional means and typically exhibit from 5 to 15 crimps per inch (cpi) and have a length within the range of ¾ to 3 inches. The binder fibers constitute from about 4 to 30% by weight of the batt and may be of the sheath/core (s/c), side/side (s/s), or monocomponent types. These may be obtained from (co)polyesters, polyolefins, polyolefin/polyester, polyamide/polyamide, e.g., and the like. Useful types of binder fibers, and their modes of functioning, are described in, e.g., “Nonwovens World”, March/April, 1990, page 37. The initial dpf of suitable binder fibers in the blend is typically within the range of 2 to 15 with a dpf of 4 being commonly used. Useful binder fibers include those disclosed in the aforementioned U. S. Patents to Scott, Pamm, Frankosky, and Marcus, together with those shown in Harris et al U.S. Pat. No. 4,732,809; Taniguchi et al U.S. Pat. No. 4,789,592; Tomioka et al U.S. Pat. No. 4,500,384; Hirose et al Japanese Patent Publication Kokai 57-210,015(1982); and others known in the art which will function within the oven temperatures disclosed herein. Preferred binder fibers include the commercially-available “Melty 4080” (Unitika Co., Japan) and the “ES” and “EA” polyolefins (Chisso Corporation, Japan).

The cured resin coatings on both faces of the batt may conveniently constitute about 10 to 30% by weight of the final bonded batt, with 12 to 25% being preferred for 1.5 to 1.65 dpf (1.83 dtex), where lesser amounts of resin tend to reduce wash durability and sealing rating while greater amounts tend to increase stiffness and reduce insulating efficiency. Moreover, the amount of resin in the surface(s) need not depend on the basis weight of the batting, and so, for heavier battings, the total resin add-on may be as little as 3%, even for slickened fiberfill batts. For entirely dry (unslickened) fibers, less resin is needed than when slickened fiberfill is used.

As noted previously, a suitable sealing resin has a T_{g} of about 0° C. or less. The useful resins are obtained from commercially-available acrylic and vinyl latex compositions among which are included, e.g., Rhoplex E-32 (Rohm and Haas Co.), TR-934 (Rohm and Haas Co.), X-4280J (Kanebo, Japan), these Hycar□ latex compositions of B. F. Goodrich Co.: 26146, 26171, 26322, 26083, 26092, 2671, 26120, 2679, 26796, these latex products of National Starch and Chemical Corporation: NACRYLIC X 4445, NACRYLIC X 788-6007, NACRYLIC X 4483, NACRYLIC X 4460, NACRYLIC X 4260, NACRYLIC X 4425, NACRYLIC X 4465, NACRYLIC 4401, NACRYLIC X 78-3990, NACRYLIC X 78-3997, NACRYLIC X 78-3905, NACRYLIC X 4280, NACRYLIC 4441, NACRYLIC 78-6114, X-LINK 2873, X-LINK 2849, X-LINK 78-6119, X-LINK 2893, X-LINK 2833, X-LINK 78-6004, X-LINK 2813, RESYN 2375, DUR-O-SET E-230, DUR-O-SET E-669, and other commercially-available latexes which are cured to resins whose T_{g} values are about 0° C. or less. Some of such commercially-available resins and their T_{g} values are listed in brochures, e.g., one by B. F. Goodrich, dated 1989, entitled HYCAR□ Acrylic Latexes, and one by National Starch and Chemical Corporation, entitled Binders, Saturants, Laminants. As the T_{g} of a sealing resin gets much lower (than 0° C.), such resins tend to become more sticky. Although such resins can provide good sealing for the surface(s) of the batting, and good wash durability, stickiness of a sealing resin can cause sewing problems, which can require slower sewing speeds, which is not generally preferred. So, the T_{g} of a sealing resin for use according to the present invention is preferably from about 0 to about −30° C.

Preparation of the batts is generally begun by conventional opening and blending of the polyester fiberfill and binder fiber, followed by carding or garnetting to make a web. This web can be layered with other webs from a train of cards or garnets, or it can be cross lapped and combined with other webs to form an unbonded batting. This batting is then sprayed with the latex composition on one or both sides of the batting and is fed to the oven for curing of the resin and bonding of the binder fibers. The oven treatment is conducted at 150-190° C. for 2 to 5 minutes, and may be conveniently done in three passes of the batt, as previously noted. The bonded batt is then passed through/around (preferably at least two) hot rolls having a surface temperature in the range of 200 to 220° C. (more than two rolls may be used). The configuration of the batting is an S-wrap over the rolls to provide maximum contact with the rolls. The latter may have a clearance of from 2 to 10 mm., depending on the final batting thickness desired. In this treatment, only one roll may be heated, if desired, even to seal both sides of the batt, which may be passed through/over the rolls a second time to heat the opposite side of the batt, if it is desired to seal both faces. Contact time on the rolls is about 8 seconds. Such hot roll treatment softens and spreads the resin to ensure its complete and even distribution on the batt surface(s) to prevent fiber leakage and to provide a uniform surface, free of lumps, for comfort and aesthetic performance in use. The batts exhibit the basis weight and thickness ranges previously indicated.

The batts of this invention exhibit desirable levels of thermal resistance or insulation, commonly reported as CLO ratings (see Hwang U.S. Pat. No. 4,514,455). Batts of this invention desirably exhibit a CLO value of at least about 0.36 CLO/oz/yd² and preferably 0.48 CLO/oz/yd² or higher.

It is to be understood that the components and processes described herein should be selected to provide the batts of this invention. Care must be taken to select combinations that do so provide. For example, the slickener on the fiber and the latex applied to the batt should be selected so as to adhere sufficiently, so that the final batt may exhibit, for example, sufficient wash durability.

### TEST PROCEDURES

CLO ratings are obtained as described in Hwang, above.

Wash durability ratings (“WD”) of the batts of this invention and of comparisons are evaluated by the procedures of ASTM D-4770-88, the panels being 24 inches×24 inches in size, and are reported for measurements made according to paragraph 8.6.1. Batts of the invention exhibit a rating of 3 or higher (paragraph 8.5 scale).

Fiber leakage or percolation through shell fabric is measured as a sealing rating (“SR”) by the method described in LeVan U.S. Pat. No. 4,869,771 (after 3 wash cycles unless indicated otherwise), a sealing rating (SR) of 5 being excellent and a sealing rating (SR) of 1 being poor. The batts of this invention exhibit a sealing rating (SR) of 3 or higher (after 3 wash cycles). In Tables 1 and 3, sealing values are additionally reported after one wash (1W) as well as after 3 washes (3W) and compared with initial values before any washing (NEW).

The softness or drapability of the batts of this invention is measured according to German Industrial Standard 53362 Cantilever (DIN 53362 Cantilever) which determines and totals the bending stiffness (“B”) of the batting in machine and cross machine directions; the combined results are related to drapability and softness. Batting Test specimens are cut for these measurements to 25 cm. length and 2.5 cm. width, and Test specimens are cut for these measurements in both machine (MD) and cross machine (XD) directions. Each Test specimen is weighed and its weight recorded as “W”. Bend length (“LU”) is then determined by sliding the Test specimen horizontally on a platform until the front of the bent Test specimen reaches an angle of 41 degrees and 30 seconds. The following calculation is then made:

B=F₁(LU÷2)³

where B=bending stiffness in cN/cm.²

LU=bend length in cm.

F₁=9.8 (W÷L)

W=weight of the specimen sample in grams

L=sample specimen length in cm.

The batts of this invention exhibit a bending stiffness (“B” being the sum of values determined for MD and XD samples from the batt) of 80 cN/cm² or less, a lower bending stiffness being preferred.

### EXAMPLES

The invention is further illustrated in the following Examples, all parts and percentages being by weight, unless otherwise indicated, calculated with regard to the “BW” (Basis Weight, i.e., to the amount of polyester filberfill and binder fiber only, (i.e., without the added resin sprayed onto the faces to improve the sealing).

### Example 1

An 82 lb. sample of a blend of (1) 1.5 dpf (1.66 dtex), solid, round cross-section, 51 mm cut length, polyethylene terephthalate staple with a polyalkylene oxide slickener (2) 42.5%, 1.5 dpf solid, round cross-section, 51 mm cut length, polyethylene terephthalate staple with no slickener and (3) 15 weight percent of “Melty 4080” binder fiber (4 dpf, 2 inch cut length), was opened by a conventional mechanical opener and fed to a hopper. In this blend, the binder fiber was already combined with the fiberfill before opening and carding.

The mixed fibers were fed to two separate garnets which each produced a continuous web about 60 inches wide and having a basis weight of about 1 oz/yd² (34 g/m²). Each web was passed through a separate cross lapper which produced a cross lapped batt which was placed on a moving conveyor whose speed was about 8 yd/min (7.3 m/min). The conveyor collected and combined both cross lapped batts into a final multiple-layered batt having a basis weight of about 2.7 oz/yd² (90 g/m²). In a continuous operation, this batt was passed into a spray zone where Kanebo's X-4280J latex (T_{g} of −4° C.) was applied to the top side of the batt which was then passed into a 3-path oven (sufficient latex was applied to provide 9% by weight cured resin on the batt). This path was at 150° C. and the resin was cured and the binder fiber activated during a residence time of about 1 minute in the oven. After the batt exited the oven, it was inverted, latex applied to the top side (“new”) of the batt, and the batt was carried by a second conveyor to a second path of the oven (170° C.) to cure the resin and activate the binder fiber (resin at 9% by weight resulted on this side of the batt to make a total of 18% by weight resin on the batt). The batting was fed to the third path of the oven (170° C.) to provide further heating of the batt for an additional minute (total heating is for 3 minutes).

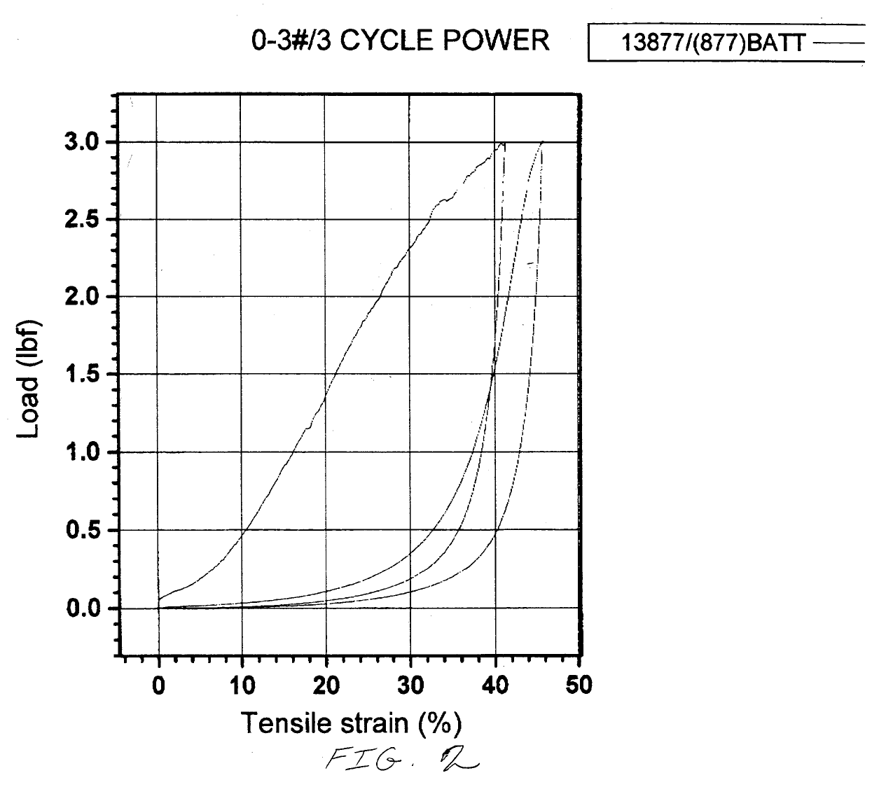

The bonded batt is passed through a pair of hot rolls in S-wrap configuration (roll surfaces at 220° C.), with a roll contact time of about 8 seconds; roll separation was 6 mm. This batting (18% resin, 15% binder fiber) had a weight of 3.33 oz/yd.², a thickness of 0.37 inch, exhibited a wash durability (WD) rating of 4, a sealing rating (SR) of 5, and total bending stiffness (B) of 37.8 cN/cm.². The stress/strain properties of the batt produced were measured as given in Table 2 below and are shown in FIG. 2. This Figure compares the effect of different sets of temperatures, times and roll clearances of the hot roll process of the present invention. In this Figure, the same sample was loaded and unloaded four times, resulting in four curves. Other properties of this batt are shown as Item No. 1 in Table 1 below.

### Comparative Example 1

In this comparative Example, another batt was produced from a blend of (1) 1.5 dpf (1.66 dtex), solid, round cross-section, polyethylene terephthalate staple with a silicone slickener (2) 27% 1.65 dpf solid, round cross-section, 51 mm cut length, polyethylene terephthalate staple with no slickener, and (3) 18 weight percent of “Melty 4080” binder fiber. Again, as in Example 1, in this blend, the binder fiber was already combined with the fiberfill before opening and carding.

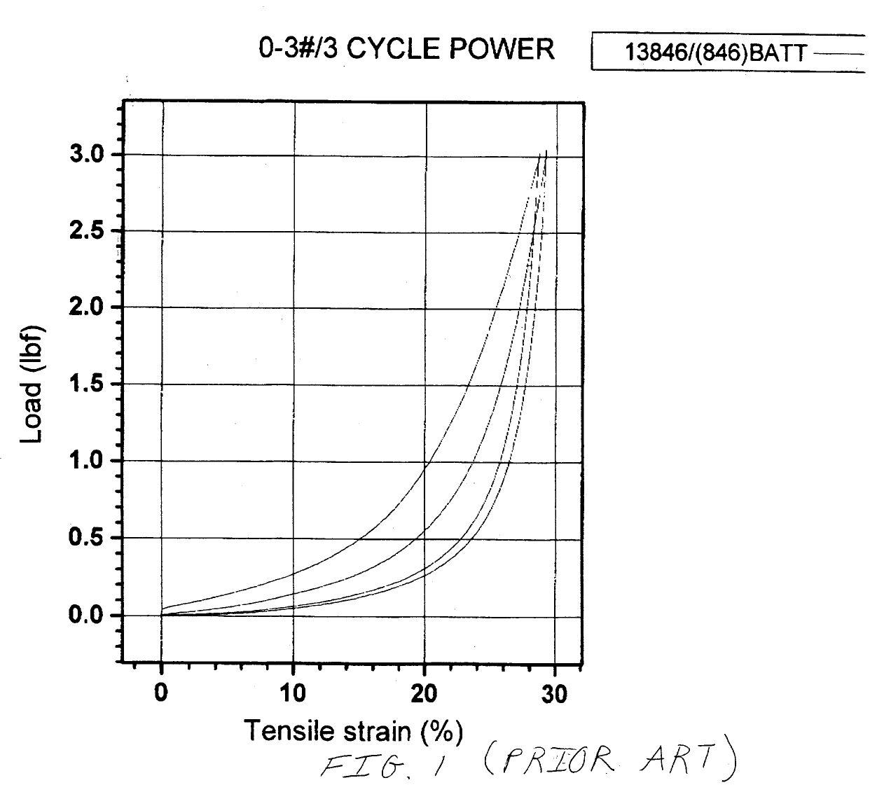

The batt was produced using the same garnetting process as described above in Example 1 and the same sealing resin, one with a T_{g} of less than about 0° C. (Kanebo's X-428OJ, T_{g} of −4° C.). The process used to make this batting was the same as in Example 1, except for the hot roll process. In this Comparative Example, the bonded batt was passed through a pair of hot rolls in an S-wrap configuration (roll surfaces at 200° C.) with a roil contact time of about 12 seconds; roll separation was 2 mm. The batt was compressed to about one half its original thickness and wound up into a roll. The stress/strain properties of the batt so produced were measured and are shown in FIG. 1. Again, in this Figure, the same sample was loaded and unloaded four times, resulting in four curves. Other properties of this batt are shown as Item No. 2 in Table 1 below.

TABLE 1

| ITEM | % | % | WEIGHT | THICKNESS | Bending Stiffness | | | | |
|---|---|---|---|---|---|---|---|---|---|
| NO. | BINDER | RESIN | (OZ/YD²) | (INCHES) | WD | SR | MD | CD | TOTAL |
| 1 | 15 | 18 | 3.33 | 0.37 | 4 | 5 | 18.5 | 19.3 | 37.8 |
| 2 | 18 | 18 | 3.07 | 0.30 | 4 | 5 | 11.7 | 11.4 | 23.2 |

What is claimed is:

1. A bonded batt, comprising a blend of polyester fiberfill intimately mixed with a binder fiber, wherein the batt has a tensile strain greater than 35% at a 3 lb. load.

2. The bonded batt of claim 1, wherein the batt is bonded throughout with lower melting binder material in complemental amount by weight about 2 to about 25% of the weight of the batt.

3. The bonded batt of claim 1, wherein the polyester fiberfill comprises about 70 to about 96% by weight of the batt, and the binder fiber comprises about 4 to about 30% by weight of the batt.

4. The bonded batt of claim 1, wherein the upper and lower faces of the batt are sealed with a resin having a glass transition temperature (T_{g}) of about 0° Celsius or less, in amount about 10 to about 30% of the weight of the batt.

5. A process for preparing a bonded batt, comprising forming a blend of polyester fiberfill and binder fiber, preparing a continuous batt from the blend, said batt having an upper and a lower face, advancing the batt through at least one spray zone, whereby both faces of the batt are sprayed with resin, heating the sprayed batt in an oven to cure the resin and soften the binder material, followed by hot rolling the heated batt at 200-220° C. for about 8 seconds to achieve intimate contact between the resin and the fibers in the faces of the batt, and cooling the rolled batt.

6. The process of claim 5, wherein the hot rolling is done by heated rolls in an S-wrap configuration.

7. The process of claim 5, wherein the rolls have a clearance of from 2- 10 mm.

8. The process of claim 5, wherein the polyester fiberfill comprises about 70 to about 96% by weight of the batt, and the binder fiber comprises about 4 to about 30% by weight of the batt.

9. The process of claim 5, wherein the resin comprises about 10 to about 300% of the weight of the sprayed batt, including the resin.

10. The process of claim 4, wherein the resin is selected to provide, after curing, a cured resin having a glass transition temperature (T_{g}) of about 0° Celsius or less.
